(19) United States
(12) Patent Application Publication
(10) Pub. No.: US 2013/0218318 A1
(43) Pub. Date: Aug. 22, 2013

(54) System for Creating Sports Themed Jigsaw Puzzles and Method of Manufacture

(71) Applicants: Kenneth Kordana, Westfield, MA (US); Janis Kordana, Westfield, MA (US)

(72) Inventors: Kenneth Kordana, Westfield, MA (US); Janis Kordana, Westfield, MA (US)

(21) Appl. No.: 13/766,843

(22) Filed: Feb. 14, 2013

Related U.S. Application Data
(60) Provisional application No. 61/601,396, filed on Feb. 21, 2012.

(51) Int. Cl. G06F 17/50

(52) U.S. Cl. CPC G06F 17/50
USPC 700/117

(57) ABSTRACT

Disclosed is a sports themed jigsaw puzzle method of manufacture and system therefor, wherein a jigsaw puzzle is created relating to a chosen sports team, player, league, or event that is of interest to an end user or customer. The method involves choosing a sports theme, compiling sports data for the given theme, creating a layout using the data, and transferring the layout from a digital format to a physical medium for fabrication of a jigsaw puzzle board using suitable manufacturing processes. The system elements allow the method to be deployed by a designer working for a manufacturer, or alternatively accept input directly from the consumer over a web user interface, whereby the consumer chooses existing puzzle layouts, requests new or unique layouts, or creates a unique and personalized layout to be made by the manufacturer.

### CROSS REFERENCE TO RELATED APPLICATION

This application claims the benefit of U.S. Provisional Application No. 61/601,396 filed on Feb. 21, 2012, entitled “Individual Years Statistics Puzzle.” The above identified patent application is herein incorporated by reference in its entirety to provide continuity of disclosure.

### BACKGROUND OF THE INVENTION

1. Field of the Invention

The present invention relates to puzzle games and methods of puzzle game manufacture. More specifically, the present invention pertains to a sports data and statistics system and method of manufacturing a jigsaw puzzle game therefrom using recent data gathered from a specific sporting event, a player, a team, or a given sports season.

Jigsaw puzzles are those that involve a plurality of interlocking tiles that form together along their perimeter edges to form a cohesive surface and a chosen message or visual when all pieces are assembled. A portion of the overall visual is provided along their upper surface of each tile such that when the puzzle tiles are assembled, the finished product allows the assembler to enjoy the puzzle theme or image. Puzzles of this type have long been available and are well described in the art. Many different styles, designs, and methods of manufacture exist for producing such puzzles. These methods include first applying the picture or image over a sheet of material using paint, an appliqué, a sticker, or some alternative marking process. Thereafter the sheet is cut into individual, interlocking tiles using a cutting process. Once the tiles are cut, they are separated and thereafter packaged for distribution. The recipient of the puzzle tiles then references the finished image, which is generally provided to the user on the cover of the puzzle tile box, while going through all of the tiles to recreate the picture by reconnecting all of the tile pieces together.

Many individuals enjoy assembling jigsaw puzzles for pleasure and as a group activity. Jigsaw puzzles provide a challenging and engaging way to spend time with friends and family, or to challenge oneself by assembling the puzzle alone. The resulting image created by the puzzle is the goal, whereby the user can enjoy his or her labor and reflect on the created artwork. Traditional puzzles include images ranging from works of art, to photographic images, and even images that facilitate learning in younger users. The present jigsaw puzzle method of manufacture and the disclosed system are designed to offer a new type of jigsaw puzzle that is directed to sports fans, whereby limitless permutations of sports data and statistics can be made available for the sports fan. The data is gathered and formed onto a visual display, wherein the puzzle assembler can enjoy the display after the puzzle is completed and the puzzle is directed to a fan's sporting interests.

The present invention pertains to a new jigsaw puzzle method of manufacture and a system therefor, wherein the puzzle picture or finished image relates to assembled sports statistics or sports data having a specific theme. The data is directed to a team of interest, a specific player, a given sport, year-end statistics for a given league, or any other notable data related to a sports figure or sports league. The data is compiled and arranged in an artistic and pleasing image that will make the assembled puzzle image, providing a sports fan with a summary of certain sports statistics or data on a given sports theme that is relevant to their interests. The data can be compiled at the end of a season or at the end of a given player's career, where a fan having interest it the subject matter purchases the puzzle with the intent of forming the final design to display the given sports data.

2. Description of the Prior Art

Devices have been disclosed in the prior art that relate to jigsaw puzzles and puzzles. These include devices that have been patented and published in patent application publications, and generally relate to learning devices and puzzles having different objectives than provided by the present invention, including those providing tools to teach young children arithmetic and association. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 6,098,980 to Ramage discloses a combination puzzle and a game board story that can be pieced together and read after the puzzle has been completed. The device comprises a story board having a front and back side and a puzzle area on the story board. The story board is segmented into a plurality of interconnected shapes that form together, that once assembled, allows a user to view the story and the symbols thereon. While the Ramage device discloses a puzzle that can assemble to form a message or story, the device fails to disclose the novel aspects of the present invention, which include the collection of sports data for the user to view once the puzzle is constructed. Further, the Ramage device fails to contemplate the system elements or the method of construction herein disclosed.

U.S. Pat. No. 6,619,661 to Collins discloses a jigsaw puzzle for young children which includes elementary arithmetic such that the device may function as a both a game and a teaching tool. The puzzle includes a number of arithmetic equations originating at the center of the board and extending outward in a radial pattern, whereby the user connects the puzzle segments to align the pieces in the order in which the equations are satisfied. An embodiment contemplates a transparent tray that is used to snap over the board and check for errors. Similar to the Ramage device, the Collins device fails to disclose a jigsaw puzzle method of manufacture and a sports statistics system for creating unique puzzles that highlight sporting events, teams, individual players, or leagues for user enjoyment after completion of the puzzle.

Similar to Collins, U.S. Pat. No. 5,743,741 to Fife discloses a mathematics jigsaw puzzle that comprises jigsaw puzzle pieces having mathematical expressions that require the user to mate adjoining puzzle pieces matching the expression on the first piece to complete an equation. Both the edge profile of the jigsaw pieces must match, as well as the mathematical expression across the pieces must be fulfilled in order to complete the puzzle successfully. As noted in Collins, the Fife device provides a unique jigsaw puzzle involving numbers and a message on the completed board, but fails to disclose the novel aspects of the present system and method of manufacture.

The present invention provides a new and unique jigsaw puzzle method of manufacture, as well as a system for choosing a given sports puzzle theme based on one's interests and ordering a puzzle to be made specifically for individual consumers. The wide range of available sports statistics and the manner in which they can be displayed provides manufacturers with considerable flexibility and a product that can adapt to new customer interests, as the puzzles can be modified based on new statistics, more popular sports, or popular players that may draw in more customers. It is submitted that the present invention is substantially divergent in design elements from the prior art, and consequently it is clear that there is a need in the art for an improvement to existing puzzle methods of manufacturing methods and systems. In this regard the instant invention substantially fulfills these needs.

### SUMMARY OF THE INVENTION

In view of the foregoing disadvantages inherent in the known types of puzzle methods of manufacture now present in the prior art, the present invention provides a new sports-directed and sports statistics jigsaw puzzle system that can be utilized providing customers with a uniquely themed jigsaw puzzle that is tailored to their sports interests and relevant to current events in the sports world.

It is therefore an object of the present invention to provide a new and improved puzzle method and system that has all of the advantages of the prior art and none of the disadvantages.

It is another object of the present invention to provide a puzzle method of manufacture that utilizes current and past sports statistics and sports data to create an artful image highlighting notable values specific to a given theme, including a sports team, player, or league, wherein the image is placed onto a physical puzzle board for a user to assemble.

Another object of the present invention is to provide a puzzle method of manufacture that allows a sports specific theme to be chosen and created, whereby individual customers can choose a theme suited to their interests and the puzzle reflects current and past sports data.

Yet another object of the present invention is to provide a sports puzzle system that allows current and past sports data to be gathered, assembled into an artful design, and placed onto a physical medium during creation of the jigsaw puzzle board.

Another object of the present invention is to provide a puzzle system and method of manufacture that offers puzzle manufacturers a new product that can rapidly adapt to customer demand, providing individualized or regionally specific puzzle boards for customers to choose from and order individually, thereby creating a product that can adapt to current market conditions and customer needs.

A final object of the present invention is to provide a jigsaw puzzle system and method of manufacture that utilizes existing technology and methods for physical creation of the puzzle board, while disclosing a new and novel theme that is adaptable to current customer demands within the puzzle game and sports memorabilia industry.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a high level flow diagram of the present method of manufacture.

FIG. 2 shows the system elements required for the present invention.

FIG. 3 shows a diagram of the final stages of the method of manufacture and before customer acceptance, wherein a design has been chosen and a puzzle board has been created.

FIG. 4 shows an embodiment of the present system that allows customers to choose a sports themed puzzle design, suggest new puzzle designs, or create a unique and personalized puzzle design based on their sports interests.

### DETAILED DESCRIPTION OF THE INVENTION

Reference is made herein to the attached drawings. Like reference numerals are used throughout the drawings to depict like or similar elements of the present sports themed jigsaw puzzle system and method of manufacture. For the purposes of presenting a brief and clear description of the present invention, the preferred embodiment will be discussed as used for creating a sports statistics and data jigsaw puzzle that is suited to customer needs and a business with inherent flexibility to accommodate customer demands and events in the sporting world. The figures are intended for representative purposes only and should not be considered to be limiting in any respect.

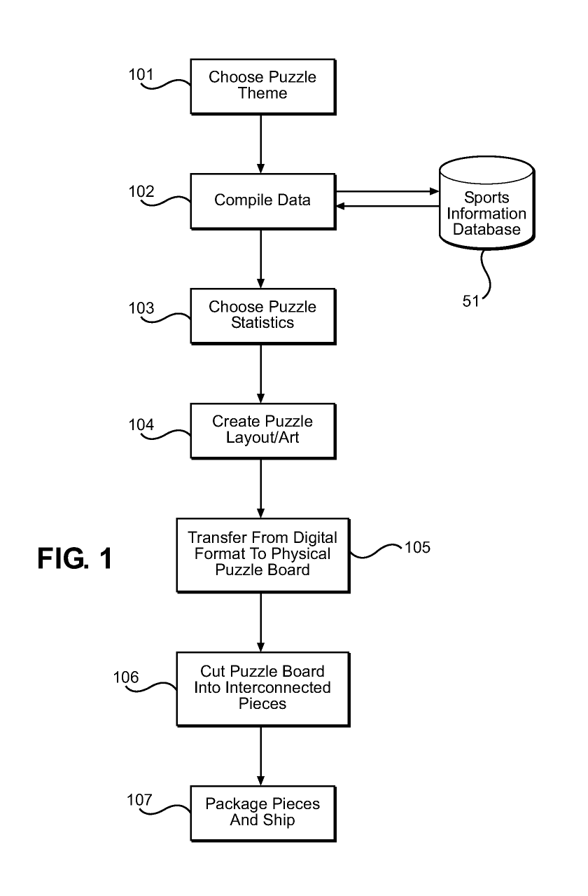

Referring now to FIG. 1, there is shown a high level flow chart of the present sports themed jigsaw puzzle method of manufacture, whereby a sports themed jigsaw puzzle is designed using sports statistics, data, and images drawn from the sports world and directed to a centralized theme. The first step in the method involves choosing 101 an appropriate puzzle theme. This may involve a manufacturer receiving input directly from customers, from market surveys, or the manufacturer deciding to make a jigsaw puzzle from a theme they desire that will be popular with customers based on geographical region, time of year, and the current sports world climate. The theme may include focusing on a given sport as a whole, focusing on a given sports team, focusing on a specific player, focusing on a major milestone and its related statistics, or any other number of chosen sports themes. Based on the chosen theme, data is compiled 102 relating to the theme from a sports statistics and information database 51. The statistics of interest are chosen 103 as it relates to the theme, such as batting statistics, scoring and assist numbers, and other notable data points that may be of interest to the end consumer for highlighting and emphasizing the chosen theme 101.

Once the relevant data has been compiled 102 and chosen 103, the layout of the puzzle board is created 104 using graphics related to the theme and an arrangement of the data using eye catching and readable format. The exact design of the layout can take on many different formats, wherein logos, player illustrations, photos, text boxes, and other forms of data presentation can be arranged to promote ease of manufacturing or accommodate a customer or customer base request (i.e. highlighting the most important aspects of the theme that the end user would desire). This step 104 of assembly of the data its layout can be inserted into a boilerplate layout that accommodates a diverse choice of themes, or alternatively the layout can be artistically and individually arranged for a given customer, depending on the manufacturer and its ability to accommodate such requests.

Once the layout of the puzzle board is established 104, the manufacturer transfers 105 the layout from a digital media to a physical media for creation of the physical puzzle board. This step may take on many different and diverse manufacturing processes for the purposes of creating an image or painted puzzle board with the chosen layout. These processes may include a painting process on the board, a printing process where a sticker or appliqué is created to be attached to the board, a printing press or impression process on the board, or any other known processes commonly utilized in the art of puzzle board manufacturing. Once the layout is transferred 105 to the puzzle board, the board is cut 106 using a cutting process to create the individual puzzle pieces or tiles. The geometry of the board and of each piece is determined by the cutting process, which supports a cutting die or jigsaw pattern that separates the board into a plurality of interconnected and separable tiles. As with the transfer of the board design, the cutting process may include any commonly utilized cutting procedure or apparatus known in the art of jigsaw puzzle manufacturing (i.e. a die cutting operation, water jet cutting, etc). It is not desired to limit the present method of manufacture to a specific printing or cutting process, but rather to disclose the novel steps leading up to these jigsaw fabrication processes, whereby a sports themed puzzle board and associated layout is created for distribution as a jigsaw puzzle for customers.

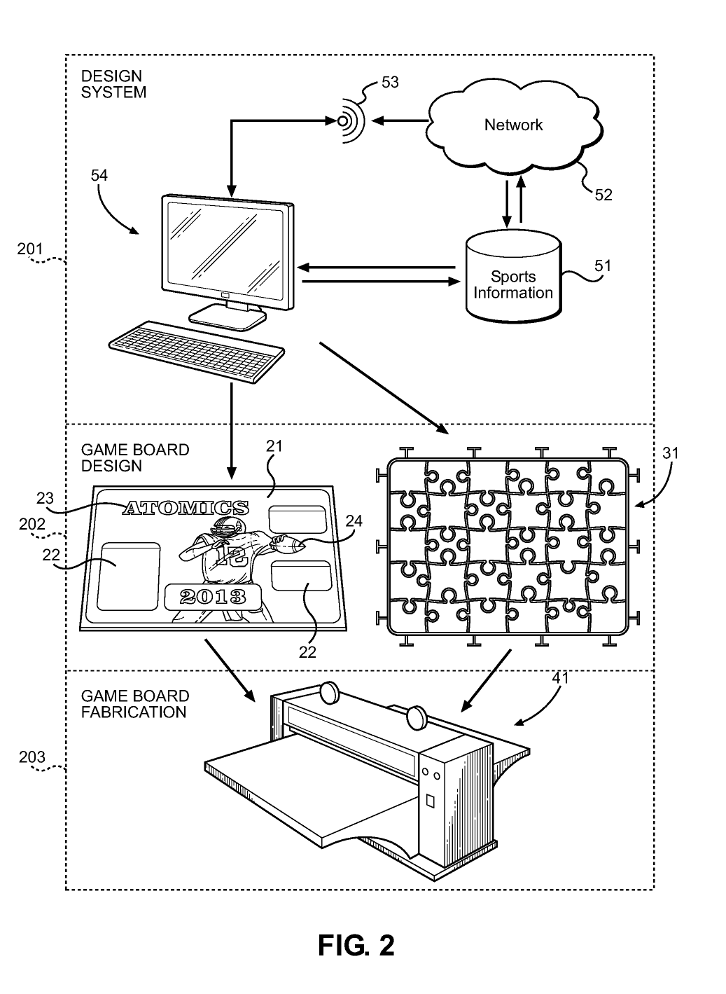

Referring now to FIG. 2, there is shown a system diagram of the present invention, highlighting the system elements utilized for implementation of the present method of manufacture. During the design phase 201, the exact theme, the chosen data to be displayed, and the art involved with the puzzle image is chosen and assembled from compiled sports data. The data is selected and compiled from a terminal 54, which can be a computing system such as a personal computer, tablet, smartphone device or any other computing means that allows for visualization of the game board layout, the sports theme and its associated data. The computing system elements include memory, storage, and a processor or similar processing means.

This design phase is implemented within the manufacturer's facility by its design employees, or as an alternative the design phase may include an end user terminal that allows a customer to navigate a manufacturer's network. Allowing the customer to select and arrange individualized or customized puzzles is a means of accommodating specific customer needs, reaching a larger customer base, and fulfilling individual orders that do not require a large inventory that may go un-purchased. The customer can choose an available puzzle theme, suggest a new theme for creation, create an individualized layout and sports theme, or browse and purchase existing puzzles created and available in the manufacturer's library of designs. On the manufacturer's side, the creation of the board involves a puzzle designer or graphic artist choosing the theme and its associated statistics from a sports data and information database 51, and thereafter arranging the theme layout. The manufacturer database 51 used by the puzzle designer may be locally stored and accessed, or alternatively may be accessed remotely through a network connection 53 and a network 52, whereby the database 51 is stored on a remote server. On the customer side, the sports data, the manufacturer's inventory and available options, the customization platforms, and the ordering processing is transacted over a network 52 that is accessed through the manufacturer's remote network (i.e. their web page over the internet). The user terminal 54 for the customer is therefore a personal computer, a tablet computer, a smartphone device, or any other electronic device that allows connection 53 to the manufacturer's website over the internet network 52.

After the puzzle theme and data has been chosen, created, or purchased, the design of the puzzle as it relates to the physical puzzle board and its individual puzzle pieces is created 202. The game board design 202 uses the layout and information chosen by the design system 201, whereby chosen graphics 24, sports information 22, and the theme title 23 can be physically applied to a chosen puzzle board 21 having a defined size and shape. The number of puzzle pieces and the geometry of each interlocking tile is chosen to correspond with the complexity of the puzzle (how many pieces desired) and the overall size of the puzzle board 21. A puzzle piece cutting template 31 is then defined based on these variables (board overall size, puzzle piece size, etc), whereby the template 31 is used to cut the board 21 into individual puzzle tiles using a game board fabrication process 203. After the board is cut to size and into individual sizes, a packaging means collects the tiles and places them in a puzzle box specific to the given theme.

The game board fabrication process 203 includes the manufacturing steps and related equipment utilized to transfer the game board design and layout from a digital medium to a physical medium, thereafter cutting the board into the individual jigsaw puzzle tiles, and further packaging the plurality of tiles into a single puzzle box. This proceeds first with a printing process, the cutting process 41, and thereafter the packaging process, whereby the layout is transferred to a puzzle game board material, cut to the chosen puzzle board dimensions and further cut into individual puzzle tiles, and collected using a packaging means within a box for consumer purchase and puzzle tile storage. The box is generally adorned with the final puzzle layout, whereby the consumer can readily recognize the sports theme of the puzzle and the user can reference the box image while assembling the puzzle, as is customary with existing puzzle board boxes. The packaging means may be a conveyor system or other suitable apparatus for collecting, separating, and funneling the puzzle tiles into the puzzle box, whereby the puzzle tiles are sufficiently separated and packaged completely and without missing tiles within the appropriate puzzle box.

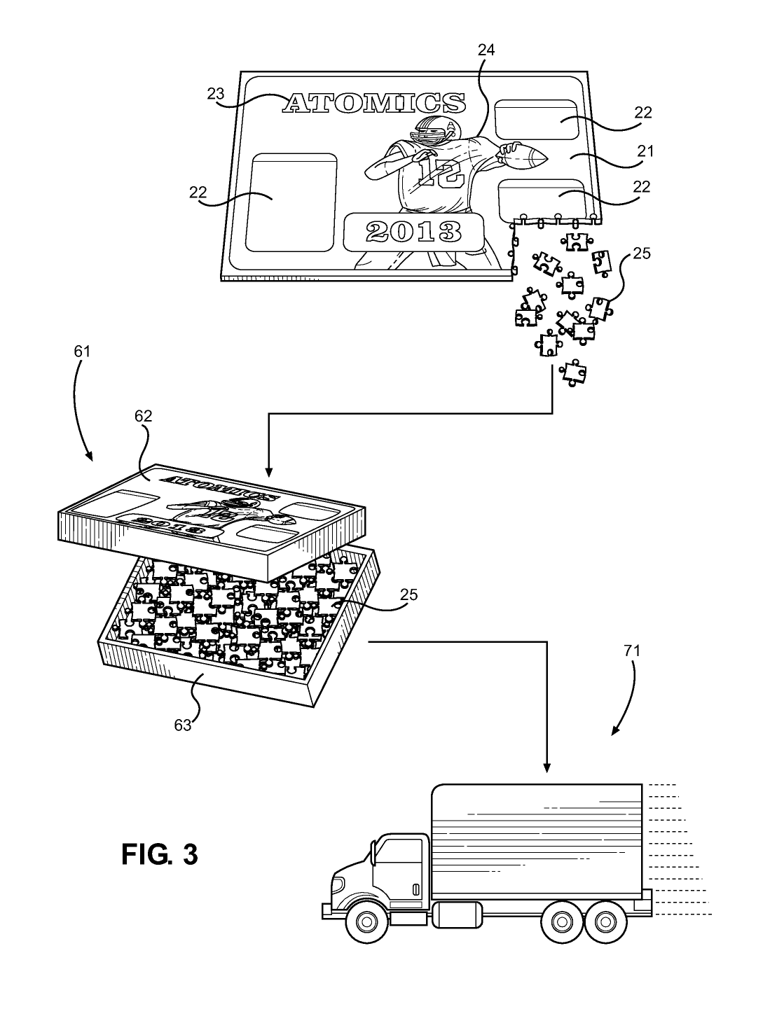

Referring now to FIG. 3, there is shown a diagram that outlines the final stages of the method of manufacture and the output of the system, whereby the puzzle layout 21 and design have been established and transferred to physical form. The theme title 23, graphics 24, and sports data 22 are outlined on the board surface, whereafter the board is segmented into a plurality of interlocking puzzle tiles 25. The tiles are packaged 61 into a box having an image 62 of the puzzle design thereon and a structure 63 suited for housing the separated and shuffled puzzle tiles 25 therein. After packaging, the box is wrapped in preparation for storage or delivered 71 to a customer.

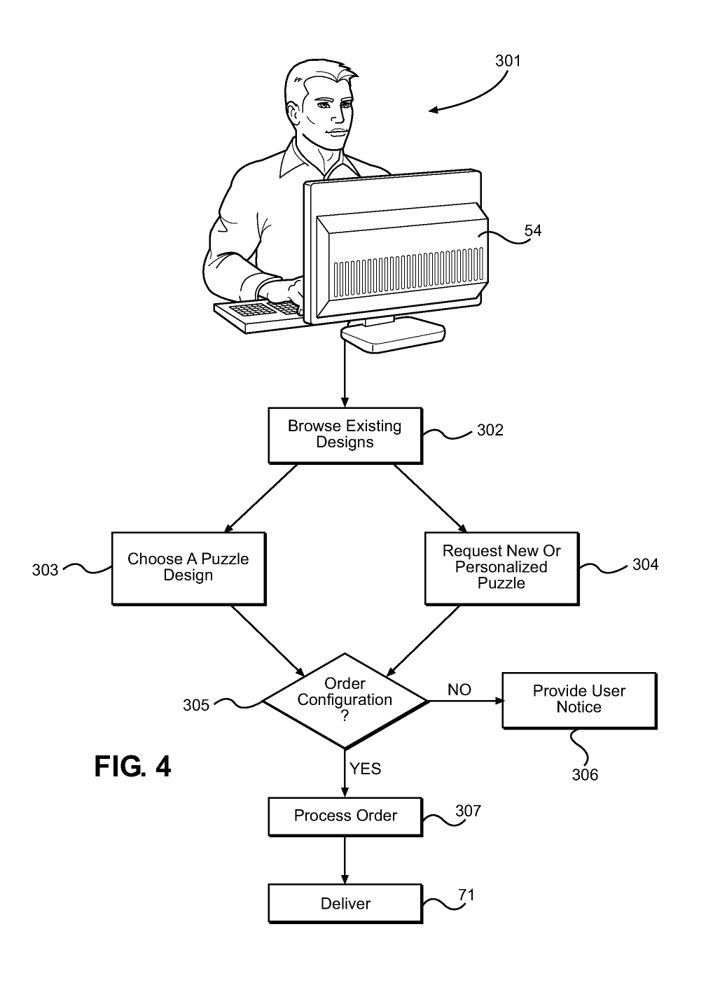

Referring finally to FIG. 4, there is shown a flow diagram outlining the steps that a customer 301 may take to order the sports themed puzzle from the manufacturer. It is desired to disclose a system that can accommodate changing customer 301 needs and the changing sporting environment by offering a means to order existing and previously designed puzzles, or alternatively allowing customers to order new or individualized puzzles for a chosen theme. The customer 301, utilizing a terminal 54 having access to the manufacturer's webpage through a user interface, can browse 302 existing puzzle designs and layouts before choosing an existing puzzle design 303 or building/requesting the building 304 of a new and personalized puzzle. When building a new puzzle design, the theme of the puzzle can be tailored toward the customer needs and the exact data for that theme can be chosen, whereafter the layout on the puzzle can be chosen and arranged. Once designed 304 or selected 303, the user can request the manufacturer to fulfill the order 305. If the manufacturer cannot fulfill a unique puzzle design or if the puzzle of choice is not available for purchase (lack of inventory, discontinued line of puzzles, etc), the customer is provided notice 306 of this fact and allowed to choose another puzzle. If the manufacturer is capable of producing the puzzle or if sufficient quantities thereof exist, the manufacturer can process 307 and deliver 71 the puzzle to the customer. The use of the term customer includes individual customers looking to order puzzles for themselves or for gift items, as well as customers that may be store owners requesting a refresh of their inventory or unique puzzles for their customers.

Overall, the present invention provides a new and unique jigsaw puzzle and means of manufacture using the disclosed steps and system elements. Customers of different geographic regions having predilections towards a local sports team, those customers wanting to commemorate a recent sporting event or achievement, those who have fondness for a chosen athlete, or those who operate a store selling puzzles can all be accommodated. The present invention is flexible to accommodate changing customer needs, wherein the final product can adapt to changing times, locations, or shifts in consumer interests. This provides the manufacturer and stores selling such puzzles with a product line that can adapt over time, stay viable, and stay relevant to the times. The puzzle can be marketed as a unique gift or enjoyment article for sports fans and enthusiasts, whereby the puzzle can be kept as a piece of memorabilia or assembled for mere enjoyment. Sports fans are provided a unique way to build puzzles, whereby specific statistics of choice are highlighted, admired thereafter, and displayed after assembly. The sports enthusiast can collect different and updated puzzles for each year and keep them as memorabilia for their favorite teams and players.

The puzzle system and method of manufacture disclosed herein provides for an infinite number of puzzle design permutations for customer purchase, whereby a sports puzzle theme highlights a given sport, team, player, time period, or other relevant data that would be of interest to the sports fan. In summary, it is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A sports themed jigsaw puzzle method of manufacture, comprising the steps of:
choosing a sports theme for a jigsaw puzzle;
compiling data based on said sports theme from a sports information database;
arranging said data into a puzzle game board layout;
transferring said puzzle game board layout to a physical puzzle board material;
cutting said physical puzzle board material into interlocking puzzle tiles;
packaging said puzzle tiles.

2) The method of claim 1, wherein said choosing a sports theme for a jigsaw puzzle further comprising the steps of:
providing a user interface and connection to a sports information database for a customer to browse sports themes, sports data, and puzzle board layouts;
receiving a request from a customer for a puzzle design.

3) The method of claim 1, wherein said choosing a sports theme for a jigsaw puzzle further comprising the steps of:
providing a user interface and connection to a sports information database for a customer to create unique puzzle layouts based on a sports theme and sports data on said sports information database;
receiving a request from a customer for a puzzle design.

4) A sports themed jigsaw puzzle system, comprising:
a user terminal comprising a computing means for compiling sports data from a sports information database and arranging a puzzle board layout using said sports data;
said computing means having a processing means, memory, and storage;
a printing means for transferring said puzzle board layout to a physical game board;
a cutting means cutting said game board to size and into interlocking puzzle tiles;
a packaging means for collecting said puzzle tiles and placing them into a box specific to said puzzle board layout.

5) The system of claim 4, further comprising:
a remote storage means, a network, and a network connection for connecting said user terminal to said remote storage means and storing a sports information database thereon.
